(19) United States
(12) Patent Application Publication
(10) Pub. No.: US 2004/0137115 A1
(43) Pub. Date: Jul. 15, 2004

(54) Stable, multi-texture, ready-to-eat desserts

(75) Inventors: Richard Leshik, Brookfield, CT (US); Lorraine A. Kopczynski, Edgewater, NJ (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/342,938

(22) Filed: Jan. 15, 2003

(51) Int. Cl. A23G 1/00

(52) U.S. Cl. 426/103

(57) ABSTRACT

A multi-texture, ready-to-eat dessert which maintains the texture of each component through extended storage is provided. To preserve the texture of each component, the soluble solid ratio between components of multi-texture, ready-to-eat desserts are matched. The soluble solids ratio is defined as 100 times the total weight of soluble solids in the layer, divided by the sum of the weight of water and weight of soluble solids in that layer.

### FIELD OF THE INVENTION

The present invention provides a multi-texture, ready-to-eat dessert, wherein the different textures are substantially preserved during storage.

### BACKGROUND

Ready-to-eat packaged foods that can be stored in a refrigerator or at room temperature, and consumed without further preparation has become the norm for many foods. Ready-to-eat desserts, such as pudding, gelatine, mousse, and the like are currently available in single-serving cups as aseptic, shelf-stable products, pasteurized products, or commercially-sterile refrigerated products. To offer a diverse selection of desserts to the consumer, food manufacturers have attempted to combine different colors, different flavors (e.g., vanilla and chocolate), or different textures (e.g., mousse and chocolate) in ready-to-eat desserts. See U.S. Pat. No. 5,417,990 to Soedjak (multi-colored gelatine); U.S. Pat. No. 6,203,831 to Eder (multi-layer chocolate/mousse dessert); and U.S. Pat. No. 6,231,902 to Grassler (chocolate pieces in mousse). These efforts have not been as successful as desired.

For desserts that combine components of different textures, it is known that ingredient migration among the components may, over time, adversely affect the texture of each component. For example, in a two layer dessert having a firm or viscous component on the bottom and a softer or liquid-like component on the top, the softer or liquid component may become more viscous or firmer, while the firm or viscous component may become soft or liquified. Various attempts have been made to address the problem. See U.S. Pat. No. 4,874,618 to Seaborne (edible, moisture resistant internal barrier for food package); U.S. Pat. No. 4,952,414 to Kaufman (use of water-in-oil emulsion to prevent softening of cereal when combined with yogurt); and U.S. Pat. No. 5,518,744 to Kaeser (use of oil to prevent softening of cereal when combined with milk product). However, the need for additional solutions persists for the problem of texture deterioration in multi-texture desserts.

### SUMMARY OF THE INVENTION

By formulating dessert components in which the soluble solids ratio between components are substantially matched with each other, multi-component ready-to-eat desserts can be made and stored without showing substantial changes in texture over time. Surprisingly, one method of matching soluble solids ratio involves the adjustment of relative amount of natural sugar in one or more of the components; the level of sweetness can be adjusted, if necessary or appropriate, by adding artificial sweeteners having high levels of sweetness. By closely matching the soluble solids ratio of the different components, it is possible to maintain the different textures over the shelf-life of the product.

### DETAILED DESCRIPTION

The formulation procedure according to the present invention provides for the development of stable, multi-texture, ready-to-eat desserts, wherein the different textures and appearances of the dessert are substantially preserved during storage. The desserts may be shelf-stable at room temperature or with refrigeration. Such multi-texture desserts include two or more components, each having a different texture from the other. For purposes of this invention, multi-texture components have sufficiently different textures, mouthfeels, or appearances are such that the textural, mouthfeel, or appearance between the components is apparent to a typical consumer upon eating the dessert. Typically, such multi-texture components could include, but are not limited to, a relatively firm component (e.g., fudge) with a relatively soft component (e.g., pudding), an aerated whipped topping on a pudding or gel, a fluid sauce as a topping on a pudding or gel, a gelled product layer with a non-gelled product, or particulates or inclusions within a pudding or gel. Layered desserts of essentially the same formulation and viscosity (e.g., parfaits or swirled puddings) are not considered multi-textured for purposes of this invention. Of course, the multi-texture components could include, for example, two relatively firm components or two relatively soft components so long as a typical consumer would appreciate the textural differences between the two components during consumption. For example, an aerated whipped topping or mousse on top of a non-aerated pudding where both have similar viscosities could have difference textures when eaten.

The components may be combined in layers or as inclusions (where one textured component is dispersed in another textured component). For purposes of this invention, “layers” or “discrete layers” is intended to include separate layers of the components as well as inclusions of one component in a layer of the other component. Examples of components include puddings, gels, mousses, custards, flans, yogurts, fudges, whipped toppings, chocolates, chocolate chips or bits, jellies, sauces, cookies, cookie dough, fruits, and the like whether imitation or real. Generally, components formed from candies, chocolates chips or bits, cookie dough, and/or fruits are in the form of inclusions. The desserts may be non-pasteurized or pasteurized as appropriate. To provide for longer shelf-life, the components are, preferably, processed at ultra-high temperatures (at least about 250° F.) and/or packaged under aseptic conditions.

Texture stability is achieved by matching the soluble solids ratio between the different components. Within each component, the soluble solids ratio is defined as the total weight of soluble solids in the layer, divided by the sum of the weight of water and weight of soluble solids in that layer, as shown in the following formula:

Soluble Solids Ratio=(Soluble Solids/(Water+Soluble Solids))×100.

For purposes of this invention, two or more layers or components are considered to have “matched” soluble solids ratios when the soluble solids ratio of adjacent components are within about 12 percent of each other, preferably within about 6 percent, and more preferably within about 1 percent. In determining the difference in soluble solid ratios between two adjacent components, it is the relative difference rather than the absolute difference which is used. Thus, for example, two adjacent layers having soluble solid ratios of 22.4 percent and 23.7 percent, respectively, have a relative difference of about 5.8 percent (as opposed to the absolute difference of 1.3 percent between the two layers).

An example of a multi-texture dessert of the present invention is the combination of a firm texture fudge layer adjacent to a pudding layer. When the soluble solids ratio are matched, the texture of each layer is substantially preserved during storage. Without matching the soluble solids ratio, the firmer layer eventually becomes softer or liquified. To adjust the soluble solids ratio, one can substitute soluble solids for insoluble solids to increase the level of soluble solids, or reduce the soluble solids in one or both of the components. As indicated above, to preserve textural differences, the relative differences between soluble solids ratios should be at most about 12 percent, more preferably less than about 6 percent and even more preferably less than about 1 percent. If a layer is thin, then the relative difference should be at lower end (i.e., about 2 percent or less). If the layers are thicker (generally about ½ inch or more), the relative difference can be at the higher end of the specified range. Without being limited by any particular theory, it is believed that each layer comes to soluble solids ratio equilibrium, probably through water migration between the layers or components. Matching the soluble solids ratio between layers or components appears to prevent excess water migration and prevent significant textural changes.

Because sweeteners usually makes up a large percentage of ready-to-eat desserts, one method of adjusting the-soluble solids ratio involves adjusting the relative levels of natural sweeteners. If necessary to compensate for reduced levels of sweetness, high intensity artificial sweeteners can be used to replace the omitted natural sweeteners. This can create an unusual dessert combination, wherein one component of the dessert is sweetened by at least some high-intensity, low usage level artificial sweetener. Examples of natural sweeteners include sugars such as, for example, sucrose, fructose, glucose, dextrose, corn syrup, corn syrup solids, honey, and the like. In the context of the present invention, sugar can refer to both sucrose and other natural mono-, di- and polysaccharides. Examples of artificial sweeteners include, but are not limited to, saccharin, Sucralose™, Acesulfame K™, and Aspartame™. Although manipulating the sweetener content of the components is a preferred method of matching the soluble solids ratio, adjustments can also be made in other soluble solids levels, water content, and/or insoluble solids (e.g., fiber, oil) levels.

The nature of the component of the desserts according to this invention is generally known to the ordinary artisan. For example, pudding is meant to include viscous fluids which have a soft gel texture, and a smooth, creamy mouth feel. Various flavors of pudding are available, including chocolate and vanilla. Mousse generally means an aerated dessert product. Fudge generally means a firm fudge having a candy-like texture. Jellies generally mean a fruit jam. Gels generally mean a water-based dessert with a gelled set. Sauce generally means a low viscosity milk phase or water phase which contains fruit and/or flavorings such as chocolate or vanilla.

The invention is further described by the examples below. It should be recognized that variations based on the inventive features disclosed herein are within the skill of the ordinary artisan, and that the scope of the invention should not be limited by the examples. To properly determine the scope of the invention, an interested party should consider the claims herein, and any equivalent thereof. In addition, all citations herein are incorporated by reference, and unless otherwise expressly stated, all percentages are by weight. In the examples below, unless otherwise specified, total and soluble solids of the components are calculated using the total and soluble solid values of the various ingredients used to prepare each component.

### EXAMPLE 1

Liquid Sauce and Thickened Pudding.

Table 1 provides the formulations for components of a multi-texture dessert. The dessert comprises a thickened vanilla pudding and a chocolate sauce as separate layers (bottom and upper layers, respectively) prepared according to known methods. Each component was prepared by heating water to about 115° F., adding emulsifier and oil, and continue heating to about 125° F. with mixing. The dry components were mixed together and then slowly poured into the heated mixture; mixing was continued for about 3 minutes. The pudding was then homogenized at about 125° F. and 2500 psi and then further heated to about 180° F. in a covered double boiler with mixing. The pudding was then cooled to about 80 to about 95° F. and poured into cups and topped with the appropriate chocolate sauce.

The three chocolate sauces (chocolate sauce 1, chocolate sauce 2, and chocolate sauce 3) differ in their percentage total soluble solids and soluble solids ratios while the percentage total solids are maintained at a constant level. Chocolate sauce 1 has a soluble solids ratio that is substantially lower than the soluble solids ratio of the pudding. Chocolate sauce 2 has a soluble solids ratio that is substantially higher than the soluble solids ratio of the pudding. Chocolate sauce 3 has a soluble'solids ratio that is well-matched with the pudding (i.e., within about 6 percent of the soluble solids ratio of the pudding). Multi-layer dessert cups were prepared with a lower level of pudding and a upper level of the individual chocolate sauces. The dessert prepared using chocolate sauce 3 was the inventive dessert. Cups containing only the individual components and desserts prepared using chocolate sauces 1 and 3 were used as controls.

TABLE 1
Chocolate Sauce on Pudding Component Formulation

| | Vanilla | Chocolate | Chocolate | Chocolate |
|---|---|---|---|---|
| Ingredient (wt. %) | Pudding | Sauce 1 | Sauce 2 | Sauce 3 |
| Water | 68.8 | 63.9 | 64.0 | 64.0 |
| Sugar | 17.0 | — | 27.2 | 18.0 |
| NFDM | 4.3 | — | — | 1.5 |
| Sodium Caseinate | — | 4.0 | 1.0 | — |
| Modified Starch | 4.8 | 2.2 | 2.2 | 2.2 |
| Cocoa | — | 2.5 | 2.5 | 2.5 |
| Locust Bean Gum | — | 0.6 | 0.6 | 0.6 |
| Vegetable Oil | 4.5 | 26.5 | 2.3 | 11.0 |
| Sodium Stearoyl | 0.2 | 0.2 | 0.2 | 0.2 |
| Lactylate | | | | |
| Aspartame | — | 0.1 | — | — |
| Salt | 0.25 | — | — | — |
| Flavor | 0.075 | — | — | — |
| Color | 0.00075 | — | — | — |
| % Total Solids | 30.5 | 35.5 | 35.5 | 35.5 |
| % Total Soluble | 20.1 | 1.8 | 28.6 | 20.1 |
| Solids | | | | |
| Soluble Solids Ratio | 22.4 | 2.7 | 30.7 | 23.7 |
| Difference in SSR | — | 88.0% | 37.1% | 5.8% |
| Relative to Pudding | | | | |

The viscosities of the separate components and the viscosities of each layer of formed dessert cups were measured after two days at room temperature. The following results were obtained.

| | Viscosity (Brookfield units) | | | |
|---|---|---|---|---|
| | Components in | Multi-layer desserts | | |
| | Separate Cups | w/Sauce 1 | w/Sauce 2 | w/Sauce 3 |
| Pudding | 33 | 23 | 38.5 | 33 |
| Sauce 1 | 28 | 45.5 | | |
| Sauce 2 | 18 | | 15.5 | |
| Sauce 3 | 25 | | | 25 |

Only the inventive sample (i.e., the multi-layered dessert using chocolate sauce 3) maintained the viscosities of both layer essentially unchanged after two day of storage at room temperature; this sample had closely matched soluble solids ratios with regard to the pudding and chocolate sauce. Thus, the textures of the two layers in the inventive sample did not change over the storage time and moisture migration between the two layers was minimized. The two other desserts exhibited significant changes in short time due to the beginning of equilibration between the two layers from moisture migration as evidenced by large changes in viscosities of the separate components and the components in the multiple-layered desserts. The largest change in viscosities was observed in the multiple-layered dessert prepared with chocolate sauce 1 which also had the largest relative difference between the soluble solid ratios of the components.

### EXAMPLE 2

Comparative Example.

A non-inventive multiple layer dessert was prepared wherein the two layers had essentially the same soluble solids levels but different soluble solids ratios. Table 2 provides the compositions of the chocolate pudding and chocolate sauce used.

TABLE 2

| | Chocolate | Chocolate |
|---|---|---|
| Ingredient (wt. %) | Pudding | Sauce |
| Water | 69.0 | 48.1 |
| Sugar | 14.4 | 16.3 |
| NFDM | 4.3 | 2.0 |
| Modified Starch | 4.4 | 1.0 |
| Cocoa | 2.7 | 2.0 |
| Vegetable Oil | 4.6 | 30.0 |
| Sodium Stearoyl | 0.2 | 0.2 |
| Lactylate | | |
| Salt | 0.3 | 0.3 |
| Flavor | 0.075 | 0.075 |
| % Total Solids | 30.2 | 51.5 |
| % Total Soluble | 18.6 | 18.7 |
| Solids | | |
| Soluble Solids Ratio | 21.0 | 27.8 |
| Difference in SSR | — | 32.4% |
| Relative to Pudding | | |

The soluble solids ratios of the two layers varied by over 30 percent. Both the individual components and a dessert prepared by layering the chocolate sauce on the top of the chocolate pudding were stored for 6 days at room temperature. The solids level of the individually stored components and of the two layers in the dessert were determined and the following results were obtained.

| | Solids (%) | | | |
|---|---|---|---|---|
| | Components in | Layers | Difference | |
| | Separate Cups | in Dessert | Absolute | Relative |
| Chocolate Pudding | 31.0 | 32.7 | 1.7 | 5.5 |
| Chocolate Sauce | 53.2 | 50.7 | −2.5 | −4.7 |

As these results indicate, there was significant water migration between the two layers in very short time. The high soluble solids ratio layer (i.e., chocolate sauce) tended to “pick up” moisture and “lose” solids while the low soluble solids ratio layer (i.e., chocolate pudding) tended to “lose” moisture and “pick up” solids. When equilibrium is reached, the original difference in soluble solids ratio will result in a difference in total solids of the two layers spit proportionally based on the relative thickness of the layers. Moisture migration in the dessert resulted in significant and undesirable changes in texture of the two layers.

These results, along with the results reported in Example 1, confirm that it is the soluble solid ratio and not the total solids percentage or soluble solids percentage that control the migration of moisture between the layers of such multiple layered desserts. The greater the difference between the soluble solids ratios of the layers in such multiple layered desserts, the greater will be the moisture migration as well as the change in texture of the individual layers.

### EXAMPLE 3

Firm Fudge Topping and Thickened Pudding.

Table 3 provides the formulations for components of a multi-texture dessert. The dessert comprises a thickened chocolate pudding and a firm fudge topping as separate layers (bottom and upper layers, respectively) prepared according to known methods. The components were prepared by heating the water and NFDM mixture to about 135° F. and then adding the remainder of the components with good mixing. The resulting mixture was then homogenized at 2500 psi, heated to 280° F. and then cooled to 85° F. in a scraped surface heat exchanger. Cups of the separate components and layered desserts prepared therefrom were then refrigerated.

The two fudge toppings (fudge 1 and fudge 2) differ in their respective soluble solids ratios. Fudge 1 has a soluble solids ratio that is substantially higher than the soluble solids ratio of the pudding. Fudge 2 has a soluble solids ratio that is well-matched with the pudding (i.e., within about 1.2 percent of the soluble solids ratio of the pudding). Multi-layer dessert cups were prepared with a lower level of pudding and a upper level of the individual fudges. The dessert prepared using fudge 2 was the inventive dessert. Cups containing only the individual components and desserts prepared using fudge 1 were used as controls.

TABLE 3
Fudge on Pudding Component Formulation

| | Chocolate | | |
|---|---|---|---|
| Ingredient (wt. %) | Pudding | Fudge 1 | Fudge 2 |
| Water | 65.8 | 21.0 | 48.9 |
| Sugar | 17.0 | 41.0 | 10.0 |
| NFDM | 6.1 | 10.4 | 5.0 |
| Modified Starch | 3.5 | — | — |
| Cocoa | 3.0 | 9.3 | 10.0 |
| Locust Bean Gum | — | — | — |
| Vegetable Oil | 4.0 | 18.0 | 25.0 |
| Sodium Stearoyl | 0.2 | 0.2 | — |
| Lactylate | | | |
| Aspartame | — | — | 0.03 |
| Salt | 0.3 | — | — |
| Flavor | 0.075 | 0.1 | 0.1 |
| Lecithin | — | — | 1.0 |
| % Total Solids | 33.4 | 78.1 | 50.3 |
| % Total Soluble | 22.2 | 50.3 | 18.9 |
| Solids | | | |
| Soluble Solids Ratio | 25.0 | 69.7 | 25.3 |
| Difference in SSR | — | 178% | 1.2% |
| Relative to Pudding | | | |

The separate components as well as multiple layered desserts (fudge on top of pudding) were stored for 120 days under refrigeration conditions. The separately stored pudding, fudge 1, and fudge 2 maintained excellent quality through the storage period with both fudge samples retaining their desired firm texture. The fudge layer on the multiple layer dessert prepared with fudge 1 essentially liquified within about two weeks. The fudge layer of the inventive dessert prepared with fudge 2, however, retained its excellent quality and firmness throughout the storage period.

### EXAMPLE 4

Whipped Topping and Gel.

Table 4 provides the formulations for components of a multi-texture dessert. The dessert comprises a strawberry gel and a whipped topping as separate layers (bottom and upper layers, respectively) prepared according to known methods. The gel was prepared by heating all ingredients to about 190° F., pouring the heated mixture into sterile vessels, and cooling in an ice bath to about 80° F. before use. The toppings were prepared by heating water to about 120° F., adding all remaining ingredients except the gelatin, homogenizing at about 5000 psi, and then cooling to about 40° F. Gelatin solids were then metered into the cooled mixture with agitation so as to keep the suspended. Once all the gelatin solids had been added, the product was pasteurized at about 207° F. in a plate heat exchanger. The topping was then cooled to about 80° F. and then whipped with sterile air to an overrun of about 150 percent.

The two whipped toppings (topping 1 and topping 2) differ in their respective soluble solids ratios. Topping 1 has a soluble solids ratio that is well-matched with the gel (i.e., within about 1.6 percent of the soluble solids ratio of the gel). Topping 2 has a soluble solids ratio that is substantially higher than the soluble solids ratio of the gel. Multi-layer dessert cups were prepared with a lower level of gel and a upper level of the individual whipped toppings. The dessert prepared using topping 1 was the inventive dessert. Cups containing only the individual components and desserts prepared using topping 2 were used as controls.

TABLE 3
Whipped Topping and Gel Component Formulation

| Ingredient (wt. %) | Strawberry Gel | Topping 1 | Topping 2 |
|---|---|---|---|
| Water | 75.4 | 68.2 | 58.5 |
| Sugar | 4.4 | 15.0 | 25.0 |
| HFCS | 18.5 | — | — |
| Gelatin | 1.1 | 0.8 | 0.6 |
| Edible Acid | 0.5 | 0.02 | 0.02 |
| Buffer Salt | 0.1 | — | — |
| Vegetable Oil | — | 15.0 | 15.0 |
| Emulsifier | — | 0.3 | 0.3 |
| Flavor | 0.06 | 0.6 | 0.6 |
| Color | 0.01 | — | — |
| Soluble Solids | 18.9 | 19.2 | 30.8 |
| Ratio | | | |
| Difference in SSR | — | 1.6% | 63% |
| Relative to Gel | | | |

Dessert cups were prepared with each of the whipped toppings (i.e., lower layer of gel and upper layer of whipped topping) and stored at refrigerated temperatures. The air cells in the topping of dessert prepared with whipped topping 2 broke down within about 1 month due to moisture migration. The topping of the inventive dessert prepared with whipped topping 1 retained its excellent quality and fine air cells after 120 days under refrigerated storage.

I/we claim:

1. A method for preparing a multi-texture, ready-to-eat dessert comprising:
(a) preparing a first component with a first soluble solids ratio;
(b) preparing a second component with a second soluble solids ratio; and
(c) combining the first and second components to form the multi-texture, ready-to-eat dessert,
wherein the first and second soluble solid ratios have a relative difference of less than about 12 percent.

2. The method according to claim 1, wherein the relative difference is less than about 6 percent.

3. The method according to claim 1, wherein the relative difference is less than about 1 percent.

4. The method according to claim 1, wherein the first component is selected from the group consisting of pudding, gel, mousse, custard, flan, yogurt, candy, fudge, whipped topping, chocolate, chocolate chip or bit, jelly, sauce, cookies, cookie dough, and fruit.

5. The method according to claim 1, wherein the first component is pudding.

6. The method according to claim 5, wherein the second component is selected from the group consisting of pudding, gel, mousse, custard, flan, yogurt, candy, fudge, whipped topping, chocolate, chocolate chip or bit, jelly, sauce, cookies, cookie dough, and fruit.

7. The method according to claim 1, further comprising treatment of both components at ultra-high temperatures.

8. The method according to claim 1, wherein the first component is sweetened by a natural sweetener and the second component is sweetened by at least an artificial sweetener.

9. The method according to claim 1, wherein the first component is sweetened by at least a sugar and the second component is sweetened by an artificial sweetener and a natural sweetener.

10. The method according to claim 9, wherein the first component sweetened by at least a sugar is also sweetened by an artificial sweetener.

11. A multi-texture, ready-to-eat dessert comprising:
(a) a first component with a first soluble solids ratio; and
(b) a second component with a second soluble solids ratio,
wherein the first and second components are arranged in discrete layers to form the multi-texture, ready-to-eat dessert and wherein the first and second soluble solid ratios have a relative difference of less than about 12 percent.

12. The dessert according to claim 11, wherein the relative difference is less than about 6 percent.

13. The dessert according to claim 11, wherein the relative difference is less than about 1 percent.

14. The dessert according to claim 11, wherein the first component is selected from the group consisting of pudding, gel, mousse, custard, flan, yogurt, candy, fudge, whipped topping, chocolate, chocolate chip or bit, jelly, sauce, cookies, cookie dough, and fruit.

15. The dessert according to claim 11, wherein the first component is pudding.

16. The dessert according to claim 15, wherein the second component is selected from the group consisting of pudding, gel, mousse, custard, flan, yogurt, candy, fudge, whipped topping, chocolate, chocolate chip or bit, jelly, sauce, cookies, cookie dough, and fruit.

17. The dessert according to claim 11, wherein both components are processed at ultra-high temperatures.

18. The dessert according to claim 11, wherein the first component is sweetened by a natural sweetener and the second component is sweetened by at least an artificial sweetener.

19. The dessert according to claim 11, wherein the first component is sweetened by at least a sugar and the second component is sweetened by an artificial sweetener and a natural sweetener.

20. The dessert according to claim 19, wherein the first component sweetened by at least a sugar is also sweetened by an artificial sweetener.

21. The dessert according to claim 15, wherein the second component is fudge.

22. The dessert according to claim 15, wherein the second component is sauce.
